(19) United States
(12) Patent Application Publication
(10) Pub. No.: US 2024/0131370 A1
(43) Pub. Date: Apr. 25, 2024

(54) Moisture Absorbing Material for a Hazardous Material Level A Suit

(71) Applicant: Gregory Speicher, Jacksonville Beach, FL (US)

(72) Inventor: Gregory Speicher, Jacksonville Beach, FL (US)

(21) Appl. No.: 17/972,971

(22) Filed: Oct. 24, 2022

(51) Int. Cl. A62B 17/00; B01J 20/10; B01J 20/28

(52) U.S. Cl. CPC A62B 17/006; B01J 20/103; B01J 20/28047

(57) ABSTRACT

The Level A hazardous material suit is designed to provide the maximum amount of protection to the individual from any substances that may irritate the skin, eyes, or respiratory systems. The Level A suit completely encapsulates the individual and provides a self-contained breathing apparatus to prevent respiratory irritants. As the person breathes and perspires within the suit, moisture accumulates within the suit and obscures the vision of the individual using the suit. This moisture will obscure the vision of the person and force the individual to leave the area. This application uses a moisture absorbing material such as silica gel to absorb this moisture to allow a more efficient use of the suit.

### A. FIELD OF THE INVENTION

In certain circumstances, it is important to protect workers from hazardous materials such as chemical substances, biological agents, or radioactive materials. Hazardous material suits (“Hazmat” suits) provide different levels of protection and the specific type of suit that is selected will depend on the possible type of exposure to the individual.

There are four different levels of protection for Hazmat suits: Level A, Level B, Level C and Level D. The Level A suit provides the greatest level of protection and the Level D provides the least amount of protection.

The Level A requires a full-face contained breathing apparatus (SCBA), a two-way radio, proper footwear including steel-toed boots and shanks on the side, and chemical-resistant gloves. The Level A suit is designed to prevent all direct contact with any harmful substance and prevent inhalation of any toxic or noxious substance in the environment. The Level A is designed for those situations that involve the most extreme cases of chemical damage that could harm the eyes, skin, or respiratory system with exposure. An example of the environment where a Level A suit is advisable would be an area that requires the individual to be in contact with or in proximity to a hazardous material.

The Level B suit requires a full-face self-contained breathing apparatus, a two-way radio, chemical resistant gloves, proper footwear including safety steel-toe boots with shanks on the outside and secured wrist, ankles, facepiece and waist areas for splash protection. An example of a situation that would require a Level B suit would be an initial site survey.

The Level C suit provides some of the same level of protection as the Level B suit but not the same level of respiratory protection. The Level C suit requires a full-face air purifying respirator, chemical resistant gloves, proper footwear including safety steel-toe boots with shanks on the outside and a two-way radio as well as a hard hat. This type of suit can be utilized when contact with the substance will not cause harm to the skin.

The Level D suit provides the least amount of protection and requires a pair of coveralls, proper footwear including safety steel-toe boots with shanks on the outside, goggles/glasses and gloves. This type of suit does not prevent inhalation of any harmful substance.

This device is to be used with the Level A suit only. This device absorbs moisture from within the suit as the person breathes and perspires normally while using the suit. The moisture absorbing agent is placed within the suit and is removable and disposable. The moisture absorbing material is meant to be disposable after a single use.

### B. PRIOR ART

There are prior art references regarding hazardous suits in general, as well as absorbent agents.

A representative example of this is Zhu, U.S. patent Ser. No. 10/456,736. The Zhu reference uses a filtering media by which air contained within the space should filter through a media. The current device is not a filtering device but is a device that will absorb moisture as the person within the suit breathes and perspires.

Another reference is Barnes, U.S. Pat. No. 7,658,891. The Barnes references uses a purification device for hazardous material. The current device does not purify the air within the suit but absorbs moisture that is produced by the person within the suit.

Other references in the relevant area of prior art include Taboada, U.S. Pat. No. 9,623,131 and Cairnes, U.S. Pat. No. 6,626,983.

None of the prior art references a device that is intended to absorb moisture with a Level A hazardous material suit.

### BRIEF SUMMARY OF THE INVENTION

Hazardous material suits are used in a variety of circumstances, including chemical spills, railroad spills, and toxic environments. It is imperative to protect the individuals who must work in these types of environments. The Level A fully encapsulated hazardous materials suit has been developed to provide the highest level of protection. This type of suit will fully encapsulate the individual and will have a face shield in the front. Additionally, the individual in the hazardous material suit will have a separate breathing apparatus.

The invention does not alter the face shield, nor does it alter the separate breathing apparatus of the individual. In one aspect, the individual moisture absorbent packets are placed along the interior perimeter of the face shield.

These moisture-absorbing materials will absorb moisture from the person who is breathing and sweating. It is inevitable that some moisture will be displaced as the person is using the suit. The amount of moisture will depend on many different factors, including the body type of the individual, as well as the frequency of breaths taken, perspiration and outside humidity.

Hazardous material suits are used so individuals can work in toxic environments and yet remain safe. However, as the person breathes and perspires, moisture will enter the Level A suit and the face shield will begin to fog. As the face shield fogs, the person in the suit will have impaired vision, which is critical.

The face shield of the device begins to fog after about five to six minutes. This, unfortunately, requires the individual to use a cloth to wipe the interior of the face shield to allow visibility through the face shield.

This results in a loss of productivity, as well as impairing the vision of the user.

The current device will place moisture absorbing gel packets in the interior of the suit. The moisture absorbing packets may be in head area in the Level A suit, but it is contemplated that the moisture absorbing material will be placed on the interior surface near the face shield to provide the best possible protection against the face shield fogging.

The moisture absorbing material may be also integrated into the suit itself.

The moisture absorbing packs are designed to be disposable; it is contemplated that packets of silica gel will be used due to cost considerations and ease of use. The exact number and shape of silica gels will depend on the individual, but it is contemplated that eight packets of fifty grams each would approximate the number that will be required.

### BRIEF DESCRIPTION OF THE DRAWINGS

FIG. 1 is a front view of the Level A hazardous material suit.

FIG. 2 is an interior view of the Level A hazardous material suit depicting the placement of the moisture absorbing material.

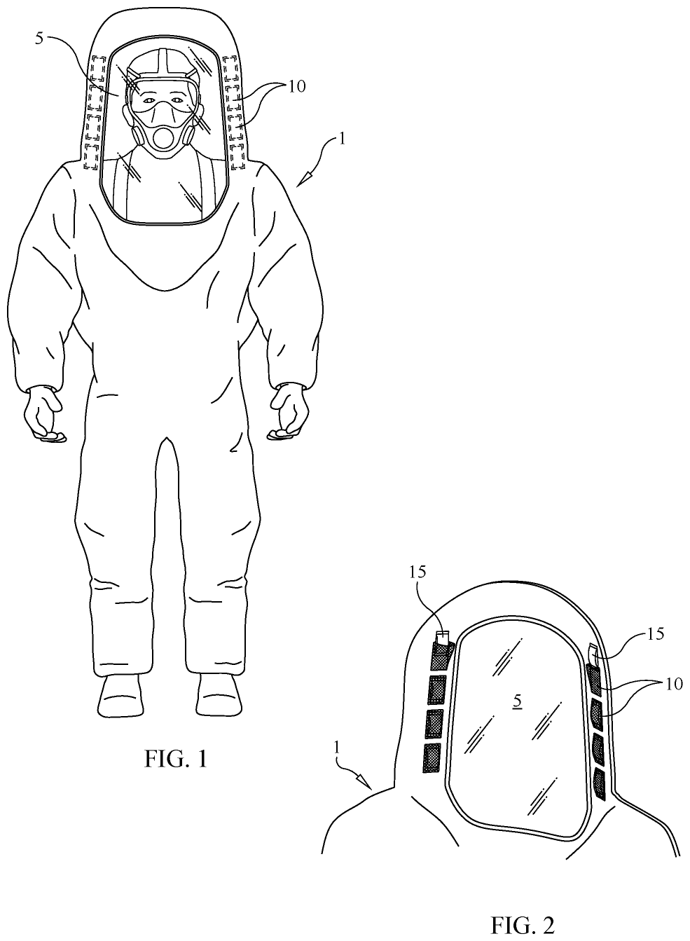

### NUMBERING REFERENCE

1 Device
5 Face Shield
10 Pockets
15 Moisture Absorbing Material

### DETAILED DESCRIPTION OF THE EMBODIMENTS

The Level A hazardous material suit is designed to fully encapsulate the individual and protect the entire individual from all noxious or irritating substances that may harm the eyes, skin, or respiratory system.

The individual that is using the Level A suit is equipped with a self-contained breathing apparatus (SCBA) within the suit itself to ensure that the person does not breathe any respiratory irritants. A face mask is provided that is connected to the self-contained breathing apparatus and is designed to fit snugly over the person's face including the eyes to prevent contact between any skin or eye irritant from contacting the person's skin or eyes. This device is not intended for use inside the SCBA mask that fits over the person's face.

The SCBA will have a separate air cylinder (not depicted) and will also have a respiratory system that fully protects the mouth and nose of an individual so that the individual does not inadvertently inhale harmful respiratory toxins.

In a Level A hazardous material suit, the individual looks through a face shield 5. The face shield 5 is transparent and permits unimpaired vision for the individual who is contained within the Level A hazardous material suit.

The face shield 5 should be made of durable material and is expected to withstand extremes of temperature as well as the extremes of the environment without failing.

On the interior surface of the hazardous material suit, will be a series of mesh enclosures or mesh pockets 10 into which absorbable material packets 15 are placed. Alternatively, the pockets or enclosures may be made as part of the Level A hazardous material suit. Flaps or other securing options to close the enclosures or pockets may also be provided to ensure that the moisture absorbing material remains in the enclosure or pockets during normal use. Although there are many types of moisture absorbing materials, it is contemplated that packets of silica gel that will be self-contained in packets will be used. Other types of moisture absorbing materials may also be used. Regardless of the type of moisture absorbing material that will be used, it should be designed to fit within the enclosures or pockets.

These moisture absorbent packets are designed to be portable and to be discarded after one use.

The amount of moisture absorbing material packets will vary depending on the particular application of the individual as well as the body type of the individual, the perspiration of the individual, and the frequency of the breath of the individual, but it is contemplated to use 8 fifty gram packets of silica gel for most operations. The pockets that house the moisture absorbing material may be made into the suit or may be contained in separate pockets for that purpose. Regardless of the type of pocket that is used, it is contemplated that it should be easy to remove the moisture absorbing material from the pocket after a single use.

The inventor claims:

1. A moisture absorbing device to be used in a Level A hazardous material suit which is comprised of:
a Level A hazardous material suit;
wherein the Level A hazardous material suit fully encapsulates the individual;
wherein the Level A hazardous material suit provides a self-contained breathing apparatus;
a face shield;
wherein the face shield is part of the Level A hazardous material suit;
wherein the face shield is a predetermined size;
wherein the face shield is transparent;
a plurality of openings;
wherein the plurality of openings are a predetermined shape;
a moisture absorbing material;
wherein the moisture absorbing material is placed within the plurality of openings.

2. The moisture absorbing device as described in claim 1 wherein the moisture absorbing material is silica gel.

3. The moisture absorbing device as described in claim 1 wherein the plurality of openings are integral to the Level A hazardous material suit.

4. The moisture absorbing device as described in claim 1 wherein the plurality of openings are attached separately to the interior of the Level A hazardous material suit.
